(19) United States
(12) Patent Application Publication
(10) Pub. No.: US 2004/0122677 A1
(43) Pub. Date: Jun. 24, 2004

(54) Telephony user interface system for automatic speech-to-speech translation service and controlling method thereof

(76) Inventors: Sung-Joo Lee, Daejeon (KR); Jae-Woo Yang, Daejeon (KR); Young-Jik Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/627,524

(22) Filed: Jul. 24, 2003

(30) Foreign Application Priority Data
Dec. 23, 2002 (KR) 2002-82856

(51) Int. Cl. G10L 11/00

(52) U.S. Cl. 704/277

(57) ABSTRACT

The present invention relates to a telephony user interface system and a control method thereof. The telephony user interface system comprises a wired and wireless telephony network interface, a user interface for performing a predetermined control procedure in order to obtain first information required for an automatic speech translation service and second information required for telephone connection with a counterpart, an automatic speech translation service system interface for performing interface between the telephony user interface system and the automatic speech translation service systems, and a system controller for performing overall control of the above interfaces.

### CROSS REFERENCE TO RELATED APPLICATION

This application is based on Korean Patent Application No. 10-2002-0082856, filed on Dec. 23, 2002 in the Korean Intellectual Property Office, the content of which is incorporated herein by reference.

### BACKGROUND OF THE INVENTION

(a) Field of the Invention

The present invention relates to a telephony user interface system for an automatic speech-to-speech translation service, and a controlling method thereof. More specifically, the present invention relates to a telephony user interface system and a controlling method of the interface system that may be applicable to an automatic speech-to-speech translation service, wherein multi-language translation is supported in real time through a wired and wireless telecommunication network.

(b) Description of the Related Art

Expansion of economic and cultural exchanges among nations increases opportunities for dialogue with foreigners through the telephone. However, difficulties may occur in cases wherein individuals are not familiar with the language in use or if the language in use is not well known to each of the communicants. In this case, it may be helpful for an automatic speech-to-speech translation service to be provided in real time through a wired and wireless telecommunication network.

In this specification, the meaning of the words “translation” and “interpretation” are to be regarded as being similar.

As one possible alternative solution to the aforementioned problem, it is expected that automatic speech-to-speech translation will be commercialized in the near future due to the extraordinary development of speech recognition, speech synthesis, and automatic interpretation technologies. In particular, when travelers visit other countries for sightseeing or business, they may feel a difficulty in communicating with people of the visited country due to the language barrier. Therefore, an automatic speech-to-speech translation service system that may support multiple languages is expected to be commercialized.

Meanwhile, a prior art relating to an interpretation service provided through the telephone network has been filed in the Korean Intellectual Property Office under the title “Interpretation guide center” (Korean Patent Publication No. 10-2001-0084990, published on Sep. 7, 2001). According to the “Interpretation guide center” technology, a telephone subscriber calls the interpretation guide center, and a particular interpreter, who is ready for an interpretation service, provides an interpretation service in the language of the subscriber. The prior art is not automatic speech-to-speech translation, but rather an interpretation relay service through specific interpreters who may communicate in various languages. Therefore, in the case in which a particular interpreter is not competent in a specific language in the interpretation guide center, it is impossible to provide the interpretation service.

In addition, another prior art relating to a telephony interpretation service using an intelligent telecommunication network was filed in the Korean Intellectual Property Office under the title “A method of telephony interpretation using an intelligent information providing system” (Korean Patent Publication No. 10-2001-0055423, published on Jul. 4, 2001). There are problems in this prior art in that-the telephony interpretation service is restrictively applied to the intelligent telecommunication network, and in that the language of a subscriber using the telephony interpretation service is designated as one particular language.

Therefore, it is required to provide a system that is accessible through conventional wired and wireless communication networks and that provides speech-to-speech translation services in real time.

### SUMMARY OF THE INVENTION

It is an advantage of the present invention to provide a telephony user interface system and a control method thereof for performing interface between a wired and wireless telephony network and automatic speech translation service systems when an automatic speech translation service supporting multiple languages is provided.

It is another advantage of the telephony user interface system and the control method thereof to realize a function for interfacing and responding to a service connection request of a user, a function for control of connection or non-connection to automatic speech translation service systems supporting multiple languages, a function for obtaining user information required in the automatic speech translation service systems supporting multiple languages and transmitting the obtained information to the automatic speech translation service systems supporting the multiple languages, a function for transmitting vocal data inputted from the user to the automatic speech translation service systems supporting multiple languages, and a function for reproducing translated vocal data of a counterpart to the user.

In one aspect of the present invention, a telephony user interface system according to the present invention performs interface between a wired and wireless telephony network and automatic speech translation service systems, and comprises:

a wired and wireless telephony network interface for processing call-related signals received from the wired and wireless telephony network;

a user interface for performing a predetermined control procedure in order to obtain first information required for an automatic speech translation service in the automatic speech translation service systems and second information required for telephone connection with a counterpart of a user, wherein the first and the second information are inputted by the user who initiates the telephone connection through the wired and wireless telephony network;

an automatic speech translation service system interface for performing interface between the telephony user interface system and the automatic speech translation service systems; and

a system controller for performing overall control of the above interfaces.

In another aspect of the present invention, a control method of a telephony user interface system according to the present invention performs interface between a wired and wireless telephony network and automatic speech translation service systems, and comprises:

(a) searching for an available communication channel in a case in which a user requests a telephone connection, and receiving a language kind and a telephone number of a counterpart of the user;

(b) making a call to the counterpart on the basis of the telephone number in the step (a) and attempting telephone connection to the counterpart;

(c) transferring a guiding message to the user and the counterpart on how to use an automatic speech translation service;

(d) receiving vocal data of the user and the counterpart and transmitting the received vocal data to the appropriate automatic speech translation system so that speech translation can be performed; and

(e) reproducing and outputting composite vocal data obtained through the speech translation to the user and the counterpart.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 illustrates a configuration of an overall system for an automatic speech-to-speech translation service in accordance with the present invention.

FIG. 2 illustrates a data processing flow in the system in FIG. 1.

FIG. 3 illustrates a service connection procedure between an automatic speech translation service system and a telephony user interface system of the present invention.

FIG. 4 illustrates a configuration of a telephony user interface system of the present invention.

FIG. 5 illustrates a control procedure in the telephony user interface system of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

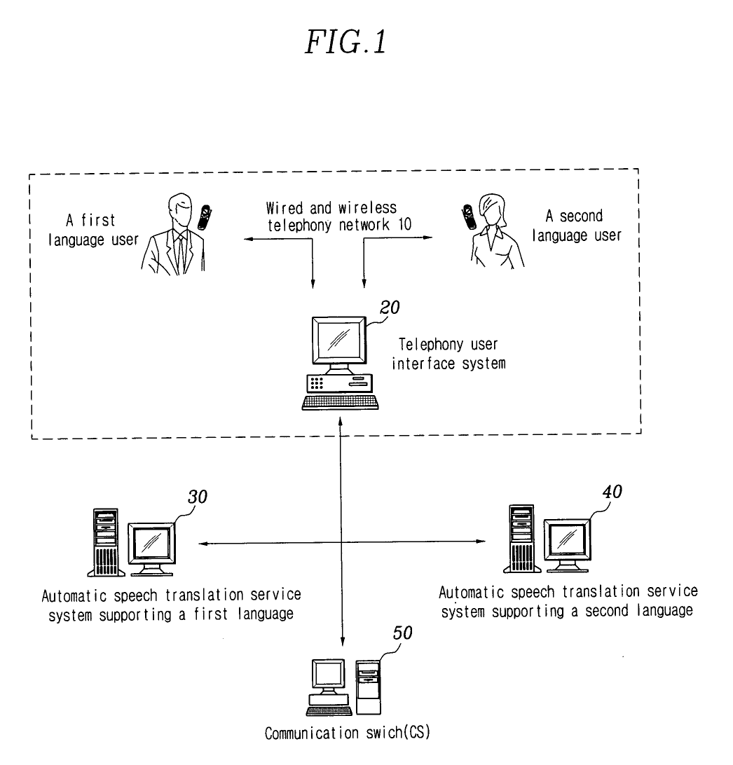

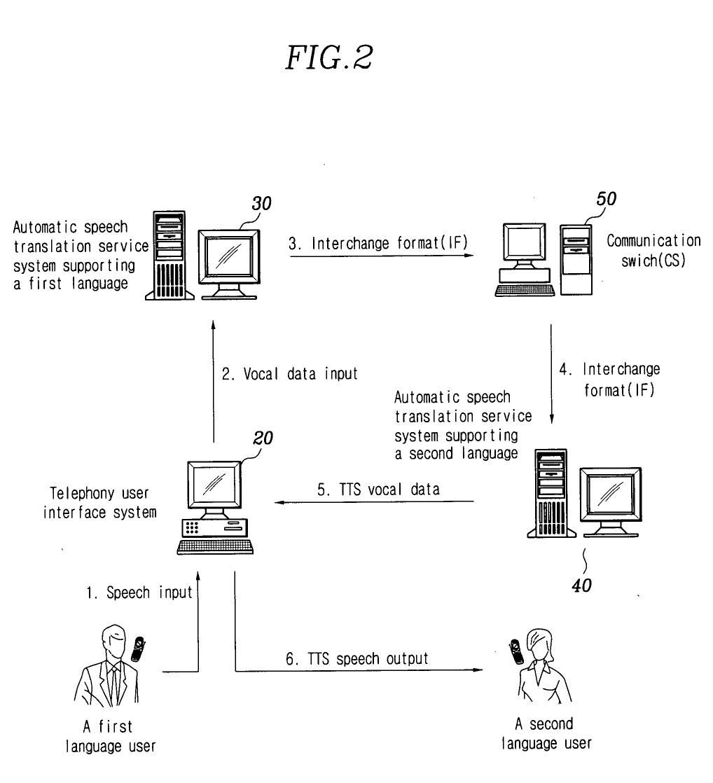

With reference to FIG. 1 and FIG. 2, an overall system for an automatic speech-to-speech translation service will be described in the following. In FIG. 1, a telephony user interface system of the present invention is applied to the overall system.

As shown in FIG. 1, the overall system comprises a wired and wireless telephony network 10, a telephony user interface system 20, an automatic speech translation service system 30 supporting a first language, an automatic speech translation service system 40 supporting a second language, and a communication switch 50.

A user who speaks the first language connects to the telephony user interface system 20 through the wired and wireless telephony network 10, and is provided with an automatic speech translation service from the telephony user interface system. Therefore, the user who speaks the first language may communicate with another user who speaks the second language. At this time, the communication switch 50 prepares for the automatic speech translation service in the case that at least two users are connected simultaneously, and the communication switch 50 is used for transmission and reception of an intermediate language. Therefore, the communication switch 50 may be omitted when only two users are provided with the automatic speech translation service.

Next, a more detailed communication procedure between the users who respectively speak the first language and the second language will be described with reference to FIG. 2. Although the description of FIG. 2 is given for the case in which the first language user requests communication with the second language user, the technical scope of this invention is not restricted to this point. In other words, the same effect may be obtained in the case in which the second language user requests communication with the first language user.

The communication procedure starts when the first language user connects to the telephony user interface system 20 through the wired and wireless telephony network 10. The voice of the first language user is transmitted to the telephony user interface system 20 via the wired and wireless telephony network 10. The telephony user interface system 20 receives the voice of the first language user, identifies the language spoken, and transmits the voice to the automatic speech translation service system 30 that supports the first language. The automatic speech translation system 30 supporting the first language automatically recognizes the voice signal received from the telephony user interface system 20, and then translates the recognized voice signal in units of sentences to generate an IF (interchange format) intermediate language. The generated IF intermediate language is transmitted to the communication switch 50. The communication switch 50 receives the IF intermediate language and determines which of the automatic speech translation service systems is to translate the intermediate language. Then, the communication switch 50 transmits the IF intermediate language to the automatic speech translation service system 40 that supports the second language. The automatic speech translation service system 40 supporting a second language translates the IF intermediate language into the second language. Then, the automatic speech translation service system 40 that supports the second language performs voice synthesis on the basis of the translated second language and transmits the synthesized voice signal to the telephony user interface system 20. The telephony user interface system 20 reproduces the synthesized voice signal and outputs the voice data to the second language user.

In view of the above-described matter, what the first language user says may be transferred to the second language user through the speech translation service for translating the first language into the second language. Thus, the second language user may understand what the first language user has said. Meanwhile, when the second language user responds to what the first language user has said, the above described procedures are processed conversely. As a result, the two users who speak in different languages may communicate with each other by using the automatic speech translation service.

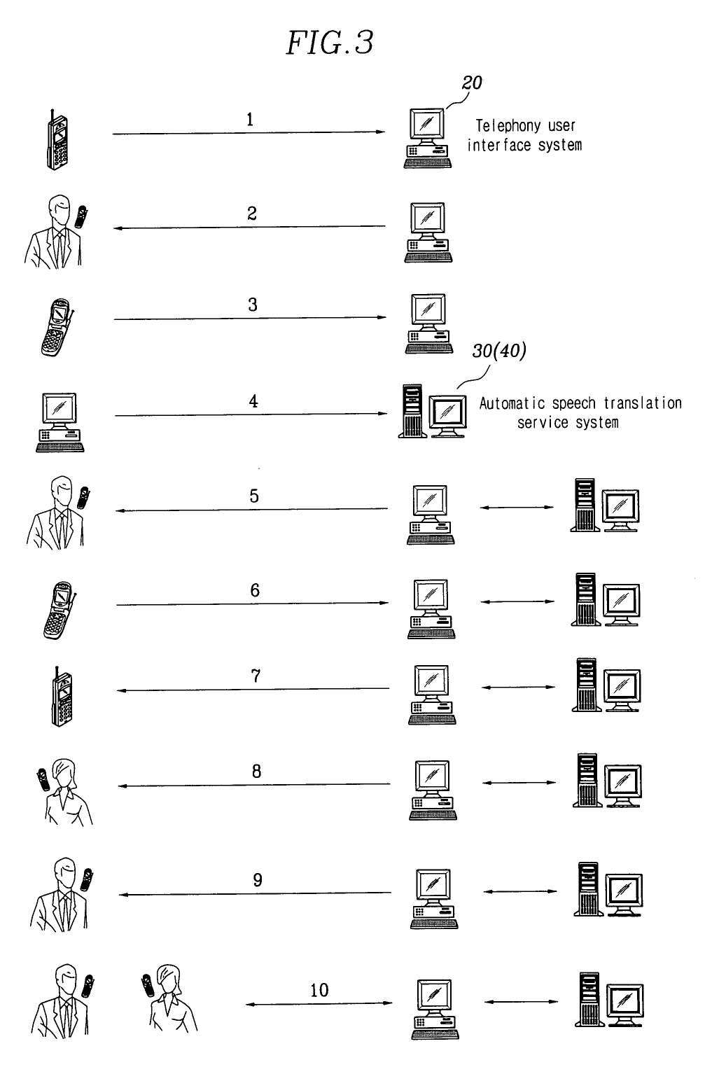

A service connection procedure between the automatic speech translation service system 30 or 40 and the telephony user interface system 20 of the present invention is illustrated in FIG. 3. More specifically, it will be described in the following how the telephony user interface system 20 may respond to a service connection request of a user and interact with the automatic speech translation service system 30 or 40. In addition, it will be described in the following how the telephony user interface system 20 may interface with the automatic speech translation service system 30 or 40 after a call is established.

At first, a user who would like to get an automatic speech translation service connects to the telephony user interface system 20 through a wired and wireless telephony network 10. In this case, it is preferably supposed that a user makes a call to a predefined telephone number for supporting an automatic speech translation service with respect to a dedicated language. For example, a user who would like to receive an automatic speech translation service with respect to Korean may make a call to the telephone number 123-4567, and a user who would like to receive an automatic speech translation service with respect to English may make a call to the telephone number 890-1234.

When the telephony user interface system 20 receives a connection request from a user, it checks whether an available communication channel for making a call to a counterpart of the user exists and sends a guide message to the user who has requested the telephone connection, in accordance with the checked result. For example, a guide message that the automatic speech translation service will not be continued may be sent to the user, when a communication channel is not available. Then, the automatic speech translation service may be terminated. On the contrary, when the communication channel is available, a guide message to the effect that the language of the counterpart should be inputted may be sent to the user.

Next, the user inputs the language of the counterpart through telephone buttons in accordance with the guide message.

A signal inputted through the telephone buttons is received by the telephony user interface system 20 via the wired and wireless telephony network 10. The telephony user interface system 20 attempts to connect with the automatic speech translation service systems respectively corresponding to the languages of the user and the counterpart.

In the case that the above connection attempt to the corresponding automatic speech translation service system fails, a guide message that the connection attempt to the automatic speech translation service system has failed and the service will be terminated is sent to the user. On the contrary, in the case that the above connection attempt succeeds, a guide message for requesting input of the telephone number or mobile telephone number of the counterpart is sent to the user.

Next, the user inputs the telephone number of the counterpart by using the automatic speech translation service in accordance with the guide message. In response to this input, the telephony user interface system 20 connects the telephone line to the number inputted by the user.

When the counterpart does not respond to the connection request, a guide message that the automatic speech translation service will be interrupted since the counterpart does not respond is sent to the user, and then the automatic speech translation service is terminated. On the contrary, when the counterpart responds to the connection request, a guide message that the automatic speech translation service is being executed is sent to the counterpart, and thus it becomes possible for the user to take advantage of the automatic speech translation service.

Next, when it is assumed that the counterpart has responded to the connection request of the user, a guide message that the automatic speech translation service is available is sent to the user. Then, the user and the counterpart communicate with each other by using the automatic speech translation service.

As described above, for the automatic speech translation service, the languages of the user and the counterpart and the telephone number of the counterpart should be inputted to the telephony user interface system 20 by the user. Moreover, many functions such as a function for connection with the automatic speech translation service systems, a function for transmitting voice data of the user to any one of the corresponding automatic speech translation service systems, and a function for receiving composite voice data as a translation result from any one of the corresponding automatic speech translation service systems and reproducing and outputting the composite vocal data to the counterpart, are required in the telephony user interface system.

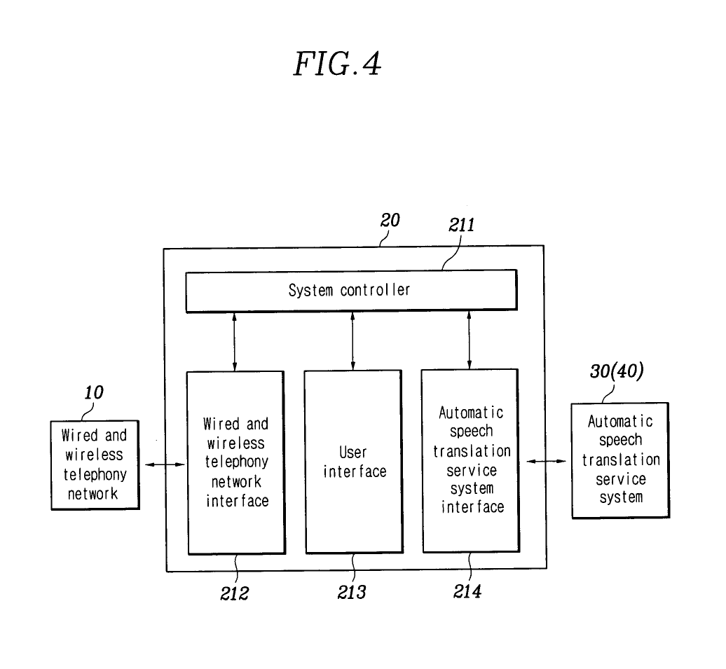

With reference to FIG. 4, the telephony user interface system having the above functions will be described in the following. In FIG. 4, the configuration of the telephony user interface system is illustrated.

As shown in FIG. 4, the telephony user interface system 20 of the present invention comprises a wired and wireless telephony interface 212, a user interface 213, an automatic speech translation service system interface 214, and a system controller 211. In addition, the telephony user interface system 20 is externally connected to the wired and wireless telephony network 10 while being externally connected to the automatic speech translation service systems 30 and 40.

The wired and wireless telephony interface 212 processes call-related signals received from the wired and wireless telephony network 10. The user interface 213 supports a predefined service procedure for obtaining information required for an automatic speech translation service in the automatic speech translation service systems 30 and 40, and information for telephone connection with the counterpart. The above information is inputted by the user through the wired and wireless telephony network 10. The automatic speech translation service system interface 214 performs interface between the telephony user interface system 20 and the automatic speech translation service systems 30 and 40. The system controller 211 performs overall control of the above described wired and wireless telephony network interface 212, the user interface 213, and the automatic speech translation service system interface 214.

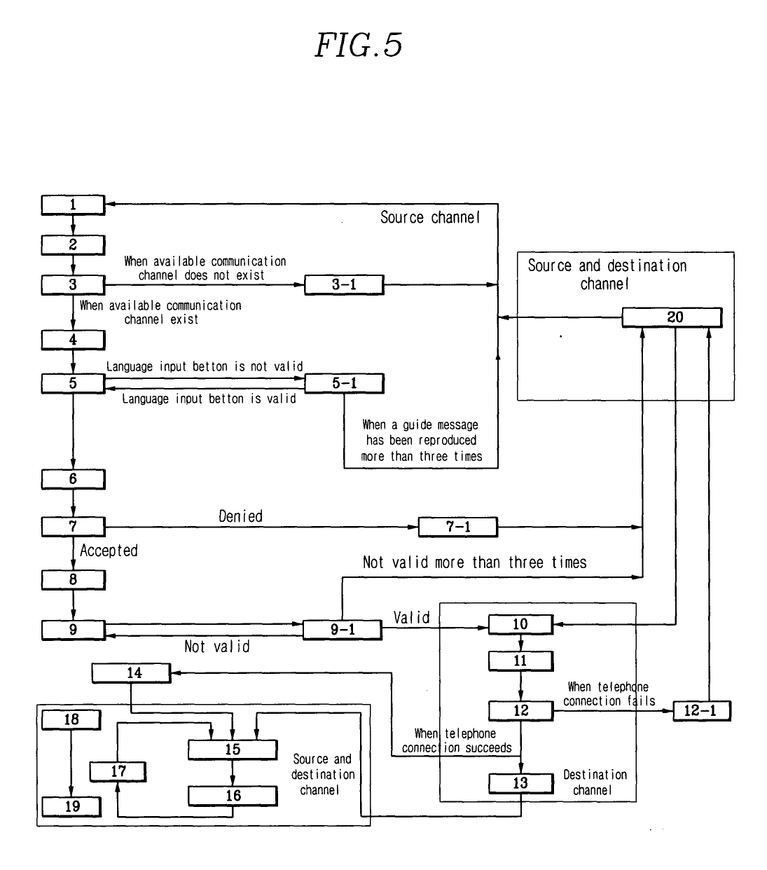

In FIG. 5, a control procedure of the present invention in the telephony user interface system is illustrated. The control procedure of the present invention comprises a plurality of blocks representing functional modules. Operation at each of the functional modules will be described below.

Step 1: The telephony user interface system performs a function for awaiting a telephone connection request from a user.

Step 2: The telephony user interface system performs a function for responding to the telephone connection request of the user.

Step 3: The telephony user interface system searches for an available communication channel to dial to the counterpart of the user. At this time, when a communication channel is not available, the control process moves to step 3-1. In step 3-1, a guide message for notifying the user that the present service will not be continued due to a lack of a communication channel is reproduced, and the present automatic speech translation service is terminated.

Step 4: When the communication channel is available in step 3, a guide message for notifying the user that the language of the counterpart should be inputted through telephone buttons is reproduced, and the telephony user interface system awaits the telephone button input of the user.

Step 5: When the user inputs the language of the counterpart through the telephone buttons, the telephony user interface system determines whether the inputted telephone buttons are valid or not. At this time, when it is determined that the inputted telephone buttons are not valid, the control process moves to step 5-1. In step 5-1, a guide message for notifying the user that the language of the counterpart should be inputted once more through the telephone buttons is reproduced, and the telephony user interface system awaits the telephone button input of the user. Differently from step 4, step 5-1 may further comprise a function in which the automatic speech translation service is terminated when the user inputs erroneously more than a predefined number of times, for example three times.

Step 6: The telephony user interface system performs a function in which it requests connection to the automatic speech translation service system on the basis of the languages of the user and the counterpart.

Step 7: The telephony user interface system performs a function in which it confirms the connection state to the automatic speech translation service system. Here, when it is determined that the connection request has been rejected by the automatic speech translation service system, the control process moves to step 7-1. In step 7-1, a guide message for notifying the user that the automatic speech translation service will not continue due to the rejection of the connection is reproduced and the present automatic speech translation service is terminated.

Step 8: The telephony user interface system performs a function that induces the user to input their mobile phone number or telephone number by using the telephone buttons.

Step 9: The telephony user interface system receives telephone number information inputted by the user through telephone buttons. Then, it is determined in a step 9-1 whether the telephone number information inputted by the user is valid or not. At this time, the telephony user interface system performs a function in which the automatic speech translation service is terminated when the user inputs an invalid telephone number erroneously more than a predefined number of times, for example three times.

Step 10: The telephony user interface system maintains a telephone communication channel to be in a stand-by state for making a call to the counterpart of the user.

Step 11: The telephony user interface system makes the communication channel be in a hang-up state.

Step 12: The telephony user interface system makes a call to the counterpart through the telephone communication channel. At this time, when the telephone connection is denied by the counterpart, the control process moves to step 12-1. In step 12-1, a guide message stating that it is impossible to make a call to the counterpart is reproduced to the user, and the present automatic speech translation service is terminated.

Step 13: The telephony user interface system reproduces and outputs a guide message to the counterpart having responded to a telephone connection request of how to use the present automatic speech translation service so that the counterpart may receive this service smoothly.

Step 14: The telephony user interface system reproduces and outputs a guide message to the user of how to use the present automatic speech translation service so that the user may receive this service smoothly.

Step 15: The telephony user interface system stands by for a specific telephone button to be inputted by the user or the counterpart. The specific telephone button is predefined for beginning of dialog.

Step 16: When the user or counterpart inputs the specific telephone button and then starts to speak, the telephony user interface system transfers the vocal data of the user or the counterpart to the automatic speech translation service system.

Step 17: When the user or counterpart has finished speaking, the telephony user interface system initializes parameters to be used and thus prepares to receive the next vocal data from the user or the counterpart.

Step 18: The telephony user interface system receives composite vocal data from the automatic speech translation service system.

Step 19: The telephony user interface system reproduces and outputs the received composite vocal data to the corresponding user or counterpart.

Step 20: When the user or the counterpart ends the telephone connection, the telephony user interface system terminates the present automatic speech translation service and initializes parameters.

In FIG. 5, a source channel represents a telephone communication channel that is required for the user to receive the automatic speech translation service. In addition, a destination channel represents a telephone communication channel that is required for the telephony user interface system to make a call to the counterpart and to provide the automatic speech translation service.

As described above, the present invention realizes an automatic speech translation service system that may support multi-language translation through a wired and wireless telephony network. In addition, the present invention provides a telephony user interface system and a control method thereof for performing interface between a wired and wireless telephony network and automatic speech translation service systems. By the telephony user interface system and the control method thereof, an automatic speech translation service supporting multi-languages may be realized in real time.

While this invention has been described in connection with what is presently considered to be the most practical and preferred embodiment, it is to be understood that the invention is not limited to the disclosed embodiment, but, on the contrary, is intended to cover various modifications and equivalent arrangements included within the spirit and scope of the appended claims.

What is claimed is:

1. A telephony user interface system performing interface between a wired and wireless telephony network and automatic speech translation service systems, comprising:
a wired and wireless telephony network interface for processing call-related signals received from the wired and wireless telephony network;
a user interface for performing a predetermined control procedure in order to obtain first information required for an automatic speech translation service in the automatic speech translation service systems and second information required for telephone connection with a counterpart of a user, wherein the first and the second information are inputted by the user who initiates the telephone connection through the wired and wireless telephony network;
an automatic speech translation service system interface for performing interface between the telephony user interface system and the automatic speech translation service systems; and
a system controller for performing overall control of the above interfaces.

2. The telephony user interface system according to claim 1, wherein the automatic speech translation service systems include a first automatic speech translation service system for supporting a first language translation and a second automatic speech translation service system for supporting a second language translation, and each of the automatic speech translation service systems translates the corresponding first or second language into an intermediate language or translates the intermediate language into the corresponding first or second language.

3. The telephony user interface system according to claim 2, wherein the intermediate language is of an interchange format (IF) type.

4. The telephony user interface system according to claim 1, wherein the first information comprises a predetermined telephone number corresponding to a language that the user requires for translation.

5. The telephony user interface system according to claim 1, wherein the user interface receives languages of the user and the counterpart and a telephone number of the counterpart from the user, and performs a function for connection with the automatic speech translation service systems, a function for transmitting voice data of the user to any one of the corresponding automatic speech translation service systems, and a function for receiving composite vocal data as translation results from any one of the corresponding automatic speech translation service systems, and reproducing and outputting the composite vocal data to the counterpart.

6. The telephony user interface system according to claim 1, wherein the telephony user interface system further comprises a communication switch for interchanging transmission and reception of an interchange language between the automatic speech translation service systems in a case in which at least two users are simultaneously connected to the telephony user interface system.

7. A control method of a telephony user interface system performing interface between a wired and wireless telephony network and automatic speech translation service systems, comprising:
(a) searching for an available communication channel in a case in which a user requests a telephone connection, and receiving a language kind and a telephone number of a counterpart of the user;
(b) making a call to the counterpart on the basis of the telephone number in (a) and attempting a telephone connection to the counterpart;
(c) transferring a guiding message to the user and the counterpart on how to use an automatic speech translation service;
(d) receiving vocal data of the user and the counterpart and transmitting the received vocal data to the appropriate automatic speech translation system so that speech translation can be performed; and
(e) reproducing and outputting composite vocal data obtained through the speech translation to the user and the counterpart.

8. The control method according to claim 7, wherein the control method further comprises performing a validity test of the telephone number inputted in (a), and then proceeding to (b).

9. The control method according to claim 7, wherein the control method further comprises notifying the user through a guide message that it is impossible to connect to the counterpart when the telephone connection attempt has been rejected from the counterpart.

10. The control method according to claim 7, wherein (c) includes notifying the user and the counterpart through a guide message of how to use an automatic speech translation service.
